(19) United States
(12) Patent Application Publication
(10) Pub. No.: US 2007/0198569 A1
(43) Pub. Date: Aug. 23, 2007

(54) Counterfeit detection

(75) Inventor: Roger G. Johnston, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: The Regents of the University of California

(21) Appl. No.: 11/443,790

(22) Filed: May 30, 2006

Related U.S. Application Data
(60) Provisional application No. 60/748,497, filed on Dec. 7, 2005.

(51) Int. Cl. G06F 7/00

(52) U.S. Cl. 707/102

(57) ABSTRACT

A method for detecting counterfeit objects relies on participation by customers who check on the validity of the unique, random, and unpredictable ID assigned to each object. Potential counterfeiters cannot reliably guess valid IDs and also cannot easily acquire large numbers of existing valid IDs. Counterfeit pharmaceuticals are detected when customers report invalid IDs and when multiple customers report the same IDs or check their own past and present stock for duplicate IDs. Some counterfeits may be detected even when only a small percentage of customers participate. The method is well suited for single-dose (“unit of use”) packaging, and can be adapted for resellers, wholesalers, repackagers, and other high-volume customers. The method can make pharmaceutical counterfeiting easier to detect and study, and make counterfeiting more difficult for the counterfeiters.

### RELATED APPLICATIONS

This application claims the benefit of U.S. Provisional Patent Application Ser. No. 60/748,497, filed Dec. 7, 2005, which is incorporated by reference herein.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally to counterfeit detection and more particularly to a method for detecting counterfeit products using randomly generated, or pseudo-randomly-generated, numeric or semi-numeric symbolic tokens.

### BACKGROUND OF THE INVENTION

Counterfeit pharmaceuticals continue to be a major problem, with serious medical and economic consequences. In theory, tags (i.e. devices, features, and/or materials that uniquely identify an object or container) that are placed on packaging, or taggants (trace amounts of a chemical added to a product or its packaging to give it a unique fingerprint, for example) could be used to authenticate pharmaceuticals and other medical or consumer products.

To be practical, tags or taggants should be (1) inexpensive, (2) difficult and/or expensive to counterfeit, and (3) quick, easy, and inexpensive for non-technical personnel to verify. It does not appear that any existing tags or taggants currently meet all three criteria. According to the Food and Drug Administration (FDA), all anti-counterfeiting technologies can be spoofed.

One factor often overlooked about anti-counterfeiting tags is that a tag need not be fully counterfeited for an adversary to be successful. In practice, only the superficial appearance and perhaps the apparent performance of the tag usually need to be mimicked, especially if the tag is to be read by non-experts, such as consumers. This is much more easily accomplished and much less expensive than completely counterfeiting the tag.

Clandestine taggants or covert tags such as secret inks and surreptitious packaging marks appear to be particularly impractical, especially for use by individual consumers. Moreover, they require keeping secrets for extended periods of time, which is not a viable long-term security strategy for consumer products sold to the general public in great quantities. Besides, the trace contaminants in pharmaceuticals already serve as a unique and hard to counterfeit “fingerprint” that can be analyzed in a laboratory, though currently at substantial cost.

Passive radio frequency transponders (RFIDs) or memory contact buttons have been proposed as anti-counterfeiting tags. It has been demonstrated, however, that they can be easily and inexpensively counterfeited.

### SUMMARY OF THE INVENTION

In accordance with the purposes of the present invention, as embodied and broadly described herein, the present invention includes a method for generating tokens. The method for generating tokens involves generating a plurality of IDs for a set of objects, each ID comprising a randomly or pseudo-randomly generated, unpredictable string of letters, digits, symbols or colors, wherein the number of object IDs is at least 100 times greater than the number of containers in the set, wherein no two object IDs for the set are the same.

The invention also includes a method for providing each of a plurality of objects with an object ID. The method involves: (a) generating a plurality of object IDs for a set of objects, each object ID comprising a randomly or pseudo-randomly generated, unpredictable string of letters, digits, symbols or colors, wherein the number of object IDs is at least 100 times greater than the number of objects in the set, wherein no two object IDs in the set are the same; (b) assigning one of the object IDs to each object in the set of objects, the set of objects comprising a lot having a lot number; and repeating step (b) for the remaining objects of the lot, wherein no two objects are assigned the same object ID in the lot.

The invention also includes labeled objects prepared by a method comprising (a) generating a plurality of object IDs for a set of objects, each object ID comprising a randomly or pseudo-randomly generated, unpredictable string of letters, digits, symbols or colors, wherein the number of object IDs is at least 100 times greater than the number of objects in the set, wherein no two object IDs in the set are the same; (b) assigning one of the object IDs to each object in the set of objects, the set of objects comprising a lot having a lot number; (c) labeling each object; and (d) repeating step (b) and step (c) for the remaining objects of the lot, wherein no two objects in the set are assigned the same object ID in the lot.

The invention also includes a method for reporting to a customer the likelihood that a product from a lot is counterfeit, where each product in the lot having a lot number and a product ID, the product ID comprising a randomly or pseudo-randomly, unpredictable generated string of letters, digits, symbols or colors, the method comprising: (a) calling in a lot number and a product ID from a customer to a manufacturer of a product or representative of a manufacturer of a product; (b) storing the called in lot number and product ID in a first database; (c) comparing the lot number and product ID to a second database of valid product IDs for the lot number; (d) determining whether or not the product ID has been called in previously for the lot number; (e) determining the likelihood that the product is a counterfeit based on results of step (c) and step (d); and (f) communicating the likelihood that the product is a counterfeit to the customer.

The invention also includes a method for reporting to a customer the likelihood that a product is counterfeit, wherein the product being inside a container, where the container has a lot number and a container ID, where the container ID comprising a randomly or pseudo-randomly, unpredictable generated string of letters, digits, symbols or colors. The method involves (a) calling in the lot number and the container ID from a customer to a manufacturer of a product or a representative of a manufacturer of a product; (b) storing the called in lot number and container ID in a first database; (c) comparing the lot number and container ID to a second database, the second database comprised of valid container IDs for the lot number; (d) determining whether or not the container ID has been called in previously for the lot number; (e) determining the likelihood that the product is a counterfeit based on the results of step (c) and step (d); and (f) reporting to the customer the likelihood that the product is a counterfeit.

The invention also includes a self-checking method for detecting a counterfeit product among a plurality of products currently or previously owned by a customer, where each product of the plurality of products has a lot number and a product ID comprising a randomly or pseudo-randomly generated, unpredictable string of letters, digits, symbols or colors. The method includes (a) maintaining a database of lot numbers and product IDs for each lot number and each product of the plurality of products; (b) determining whether or not there are any duplicate product IDs for each lot number; and thereafter (c) determining the likelihood of whether any of the products are counterfeit.

The method also includes a self-checking method for detecting a counterfeit product among a plurality of products currently or previously owned by a customer, where each product of the plurality of products has a lot number and a container ID comprising a randomly or pseudo-randomly generated, unpredictable string of letters, digits, symbols or colors. The method includes (a) maintaining a database of lot numbers and product IDs for each lot number and each product of the plurality of products; (b) determining whether or not there are any duplicate container IDs for each lot number; and thereafter (c) determining the likelihood of whether any of the products are counterfeit.

The invention also includes a system for a container, the system comprising (a) a microprocessor for storing and transmitting information that is stored in the microprocessor, the stored information comprising a lot number and a container ID for said container; (b) an acoustic encoder and driver for controlling a speaker, said acoustic encoder and driver being in electrical communication with said microprocessor; (c) a speaker in communication with said microprocessor and said acoustic encoder and driver for sending an acoustic signal that comprises the lot number and the container ID; (d) an actuator for initiating the acoustic signal from said speaker; and (e) a source of electrical power in electrical communication with said microprocessor, said acoustic encoder and driver and said speaker.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 shows a printed representation of the token, applied to a pill bottle, packaging, or other pharmaceutical container. In this embodiment, the token, which is part of a container ID, also called a Bottle ID, includes the letters KSD and the numeric digits 709.

FIG. 2 shows four graphs of the percentage of callers reporting the same valid Bottle ID who will be notified their drugs are likely counterfeit vs. the number of callers reporting that Bottle ID. Each graph is for a different threshold (T) of callers (2 callers, 3 callers, 5 callers, and 10 callers) for declaring that counterfeiting has occurred for a particular lot and Bottle ID. It is assumed that counterfeiters have created a large number of counterfeits with the same valid Bottle ID number. If earlier callers are contacted again, or call back later and identify themselves as being recallers after the call-in threshold has been achieved for a given Bottle ID and lot number, then 100% of all callers will be informed they hold counterfeits rather than the percentage plotted here.

FIG. 3 shows an embodiment container of the invention. A customer can use the container to find out if a product inside the container is a counterfeit by calling in, holding the container close to the telephone and pressing an actuator (a button, for example), which causes a microprocessor to send an electrical signal to an encoder and driver, which causes a speaker to generate sounds (such as the DTMF (dual tone multi frequency) telephone tones commonly used by telephones) that communicate the Lot number and product ID or container ID over the telephone. The telephone system itself does not need to use DTMF for the operation of this embodiment.

### DETAILED DESCRIPTION

The invention is concerned with generating tokens that are unique identifiers of objects. For the purposes of this invention, a token is called an “object ID”. When the object is a product (a consumer product, a pharmaceutical, for example), the token is called a “product ID”. When the object is a container, the token is called a “container ID”. For pharmaceuticals, the container ID is sometimes called a “Bottle ID”.

The invention is also concerned with using the token to check the authenticity of objects.

The invention may be applied to a wide variety of products, containers, and products inside containers. Preferred products include, but are not limited to, consumer products (e.g. sporting goods, apparel, recorded electronic media, furniture, precious stones, jewelry, cosmetic products, and the like) and agricultural products. Other preferred products include medical products, particularly when they are produced in large quantities and sold to numerous customers. Pill bottles are a preferred container, and pills (such as pharmaceuticals) are a preferred product.

It has been demonstrated using statistics that that the invention may be used efficiently for identifying counterfeits. The invention may be used to, at least partially, detect counterfeits and impede counterfeiters at a relatively modest cost by allowing customers, including individual consumers, to check on the authenticity of a product they have purchased without the requirement of a tag reader, such as is required with RFID tags.

An aspect of the invention is sometimes referred to herein as the “Call-In the Numeric Token” (CNT) method. The CNT method may be used with medical products, such as pills (i.e. pharmaceutical containers) and containers for the products (pill bottles). For this embodiment, the CNT method requires (1) a unique product or container identifier called a “product ID” or “container ID”, respectively. Each product ID or container ID includes a randomly or pseudo-randomly generated string of unpredictable letters, digits, symbols or colors; (2) a secret first database of Bottle IDs maintained by the pharmaceutical manufacturer or the representative of the manufacturer; (3) a dedicated Internet web page and/or automated telephone line(s) for customers to “call-in” to report their Bottle ID(s) and receive feedback about the probability they possess counterfeit pharmaceuticals; (4) customer participation in the calling-in process; and (5) participation by high-volume customers in an independent self-checking process that involves looking for duplicate Bottle IDs in their current and previous inventory.

When using the CNT method to detect pharmaceutical counterfeits, the term “customer” is meant to include individual consumers, wholesalers, repackagers, consolidators, brokers, pharmacies, hospitals, and other companies and institutions that handle large volumes of pharmaceuticals.

Currently, most pharmaceutical containers or packaging are marked with the appropriate Lot Number and Expiration Date. The CNT technique requires that an additional identification (ID) number be applied. This ID number, an example of a token that is sometimes referred to herein as a “Bottle ID”. The token is a randomly- or pseudo-randomly-generated, unpredictable string of letters, digits, symbols, or colors.

A token of the present invention may be applied to a product, to a container, or to packaging. It may be applied to, for example, a pharmaceutical container such as a tube, box, drum, pallet, or even a truck, depending on the application. The token may be inserted into (or printed on) the container and/or packaging during manufacture, or else added at a later date by applying an adhesive label. In the latter case, it likely does not matter which label goes on which container as long as the label is applied to the correct lot.

It should be understood that is not a requirement of this invention that the token be physically attached to the pharmaceutical container or that it even be located in the same location.

In an embodiment, a token may be appended to a lot number or inserted into the lot number. Preferably, the token and the lot number are separate from each other.

For the example of a pill bottle for pharmaceuticals, a “Bottle ID” is generated for each bottle. Random or pseudo-random generation of the “Bottle ID” may involve, for example, the use of a portable random number generator; the use of a random number generator based on radioactive decay; quantum effects; the use of complex or chaotic mechanical motion or computer generated computations; photonic, thermal, or electronic noise; the use of a number generator based on extracting data from voluminous sources such as telephone books, tables of data, hard disks, computer interrupt events, the Internet, and the like; the use of a random number generator based on the unpredictable time of human actions such as, but not limited to, the time to press down a button, delay times between typing keyboard letters, and the like.

A token for an object is chosen according to certain rules. The rules apply for choosing a token for any object. The example below describes these rules as they apply to choosing a token for a bottle of pharmaceuticals. In this case, the token is called a “Bottle ID”.

Rule 1: The “Bottle ID” must be a set of numbers, letters, symbols, and/or colors for each bottle within a given manufacturing lot. Two bottles of the same product can have the same Bottle ID only if they come from a different manufacturing lot.

Rule 2: The “Bottle IDs” are not serial numbers. They must be random (or pseudo-random), non-sequential, and unpredictable.

Rule 3: There must be at least 100 times more possible “Bottle IDs” than actual bottles produced for a given manufacturer's Lot. Preferably, there are at least 1000 times more possible “Bottle IDs” than actual bottles produced for a given manufacturer's lot.

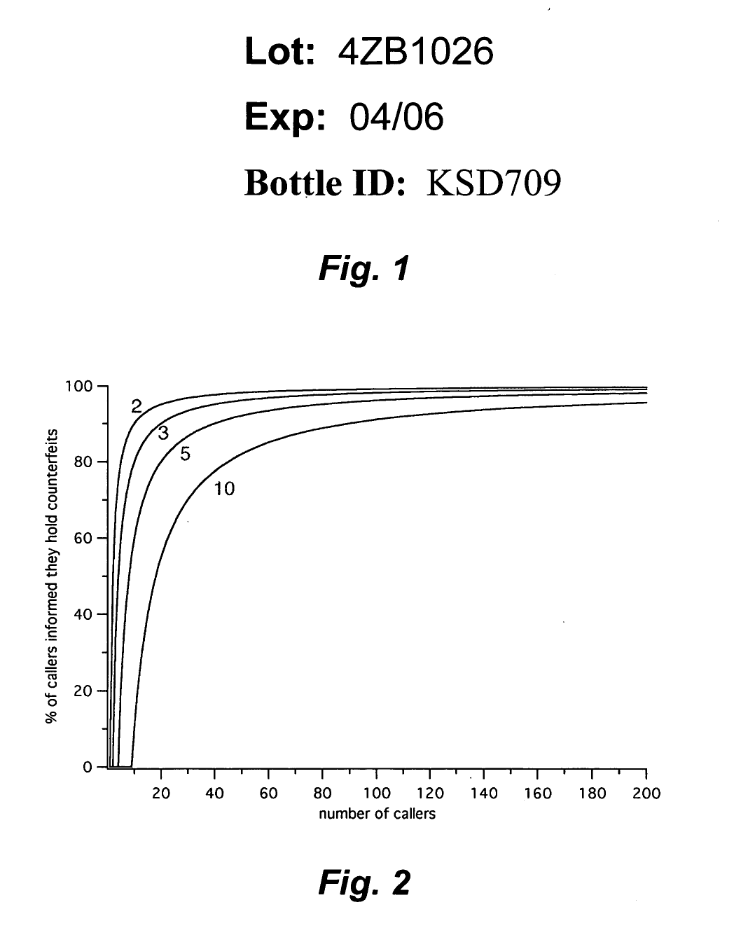

FIG. 1 shows an example of a “Bottle ID” token. The “Bottle ID” format in this example includes 3 letters followed by 3 numeric digits. Such a “Bottle ID” allows about 17.6 million unique “Bottle ID” numbers, and thus up to 17,576 different bottles (under Rule 3 above) for this lot.

TABLE 1 below shows the number of unique “Bottle ID” and bottles per lot for various “Bottle ID” formats when there are at least 1000 times more possible Bottle IDs than actual bottles produced for a lot.

TABLE 1

| | | |
|---|---|---|
| | Number of | |
| | Possible Unique | Maximum Number |
| Bottle ID Format | Bottle IDs | of Bottles per Lot |

| | | | |
|---|---|---|---|
| 6 digits | 1 | million | 1,000 |
| (2.5 bytes) | | | |
| 7 digits | 10 | million | 10,000 |
| (2.9 bytes) | | | |
| 3 letters + 3 digits | 17.6 | million | 17,576 |
| (3.0 bytes) | | | |
| 4 letters + 3 digits | 457 | million | 456,976 |
| (3.6 bytes) | | | |

In practice, some letters (the letters O, I, and lower case L) may be excluded if they cause confusion with digits (0, 1). This modification would only slightly change the values shown in TABLE 1.

It is not a requirement of the invention to use a consistent format for the “Bottle IDs”, either within a given lot or among different lots. Variability may further frustrate a counterfeiters' ability to guess valid “Bottle ID” numbers.

Only the “Bottle IDs” printed for a give lot are valid for that lot. Any bottle with a non-valid “Bottle ID” must be considered counterfeit.

In a preferred embodiment, a computer and computer database are used to keep track of the valid “Bottle IDs” for a given lot. The computer database of valid “Bottle IDs” must be kept secret by the pharmaceutical manufacturer a representative, at least until the appropriate lots expire. Keeping track of the valid “Bottle IDs” using a computer requires only a modest amount of storage space. About 53 kilobytes are needed per lot for the “Bottle ID” format of three letters and three numbers (about 3 bytes times 17,576 bottles), for example, which is shown in TABLE 1. Presently, a single compact disc (CD) or digital video disc (DVD) could hold data for 250 million and 1500 million bottles, respectively. Data compression would permit an even greater capacity.

Preferably, a pharmaceutical manufacturer, its representative, the government, or an association of manufacturers, would establish a public Internet site and/or dedicated telephone lines. In a preferred embodiment, a telephone line is automated with voice recognition software to simplify its use for consumers. An Internet website and/or telephone line would allow customers to quickly check (manually or via computer automation) whether their Bottle IDs are valid for the appropriate lot number(s). This is termed “calling in”. When a customer calls in, the customer is only given a yes or no response. In a yes response, the customer is informed that the bottle in question appears to be authentic. In a no response, the customer is informed that the bottle in question does not appear to be authentic. If a customer is given a no response, the customer would be encouraged to return the pharmaceutical(s) to the manufacturer for analysis, and to obtain a replacement.

Regardless of the number of other customers who call in, a customer's invalid Bottle ID(s) can be immediately identified by the Internet website or telephone line when the customer calls in. An invalid Bottle ID indicates that the drug is counterfeit, unless the customer made an error or is not being sincere.

High-volume customers can identify some counterfeits by noting duplicate Bottle IDs within their own current and previous stock. This is called “self-checking”. In a preferred embodiment, self-checking involves automated reading (such as via RFIDs or bar coding) and data logging of the lot numbers and Bottle IDs. Because counterfeits tend to cluster in time and space, self-checking can be very useful for detecting counterfeits.

If multiple customers call in with identical, valid Bottle IDs, most or all of their pharmaceuticals are counterfeits. In this situation, counterfeiters are replicating at least some valid Bottle IDs to assist in their drug counterfeiting.

It is possible for counterfeiters to obtain one or a few valid Bottle IDs. However, it is challenging for counterfeiters to obtain large numbers of valid Bottle IDs because (1) counterfeiters would need access to large numbers of authentic bottles or to a secret database of valid Bottle IDs, which is unlikely, and/or (2) each newly manufactured lot has new Bottle IDs assigned to it.

If only a few Bottle IDs have been replicated in large numbers by counterfeiters, pharmaceutical manufacturers could issue public warnings about those specific Bottle IDs. The FDA's MEDWATCH system, for example, could be used to issue such a public warning, which may alert customers who do not call in.

It may be advantageous to barcode the lot number and Bottle ID on the bottle or packaging. It may also be advantageous to store the lot number and container ID in a radio frequency transducer (RFID), memory contact button, or the like.

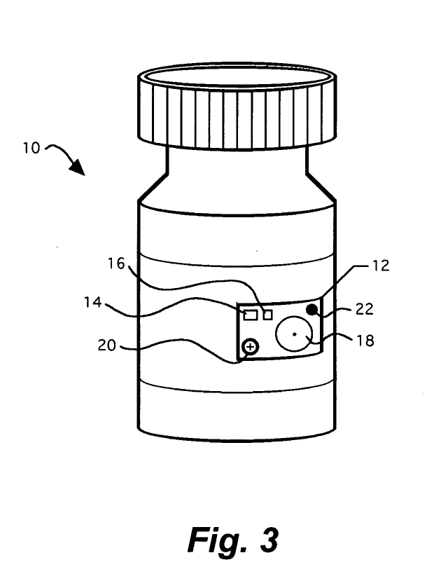

The lot number and Bottle ID may be encoded in a system. FIG. 3 shows an embodiment system attached to a bottle of pharmaceuticals. Bottle 10 has attached system 12 that includes microprocessor 14. Information stored in the microprocessor includes the lot number and Bottle ID, and optionally the product ID for the pharmaceuticals inside bottle 10. It should be understood the term microprocessor is meant to include any device capable of performing the functions of storing the information and controlling the release of the stored information. System 12 also includes acoustic encoder and driver 16, speaker 18, battery 20, and actuator 22 (a button, thermal sensor, capacitive sensor, switch, or the like). Microprocessor 12 controls acoustic encoder and driver 16, which drives speaker 18. Battery 20 supplies all the necessary electrical power to system 12. During operation, a user depresses actuator 22, which causes microprocessor 14 to send the stored information to the acoustic encoder and driver 16 and then to speaker 18, which sends an acoustic signal of the lot number and Bottle ID and optionally the product ID through the air.

The acoustic signal may have the format of a synthesized or recorded human voice. A preferred embodiment for the acoustic signal is one having a DTMF (dual tone multifrequency) format, which is widely used with telephones. This would make it possible to at least partially automate the “calling-in” and “self-check” processes. A customer can use the container to find out if a product inside the container is a counterfeit by calling in, holding the container close to the telephone and pressing the actuator, which causes a speaker to generate sounds that communicate the lot number, container ID (and optionally the product ID(s)) over the telephone. The telephone system itself does not need to use DTMF for operation of this embodiment. The number of times the sound is emitted from the system is limited to one or a small number (4 times, for example) of button presses, thereby limiting the number of times the same Bottle ID can be called-in, thereby reducing the incidence of inadvertent, redundant call-ins by the same consumer for the same product or container. Alternatively, the acoustic signal can communicate, in addition to the lot number and container ID, the number of times that the actuator had been used to initiate an acoustic signal. This could be used to limit the number of redundant call-ins from the same customer with a particular bottle.

A system of the invention based on the aforementioned DTMF format may be fabricated using commercially available parts, for example: an exemplary microprocessor is available from MICROCHIP as model number PIC16F819-I/SS-ND, an exemplary actuator is available from PANASONIC as button model number P12282SCT-ND, and an exemplary acoustic encoder and driver is available from NPC as model SM8230A. It should be understood that these types of parts are widely used, and that other microprocessors, actuators, and drivers could be used instead.

The combination of a token such as a Bottle ID, together with the calling-in and self-checking steps may be used as a countermeasure against counterfeiting.

A Bottle ID may be placed inside tamper-evident packaging, making it more difficult for would-be counterfeiters to surreptitiously obtain large numbers of valid Bottle IDs. The Bottle ID can be etched inside the bottle using, for example, a laser or energetic beam such as an ion beam. It can be written on tear-off labels, or on scratch-off labels such as those used for lotteries. Bottle IDs in this form are expected to reduce the chance that a customer would mistakenly call-in the same Bottle ID multiple times. A magnetic stripe that is erased in the process of being read may accomplish the same thing, as can a frangible film, with the Bottle ID printed on it that is destroyed when the consumer attempts to withdraw the first pill.

It should be understood that it is not necessary for Bottle IDs to be physically inside or attached to the packaging, or even shipped at the same time as the pharmaceuticals (see scenario 9 below). Instead, Bottle IDs may be mailed or emailed to a customer at a later date, perhaps using encryption for added security. In this situation, the Bottle ID is not a physical tag. Each valid Bottle ID and associated lot number is effectively an authorization to own 1 bottle. If the bottles are resold, the purchaser must insist on receiving an equal number of valid Bottle IDs, and should call in each of the Bottle IDs (i.e. call in each of the tokens) to see if they are valid.

In a preferred embodiment, software and readers may be provided to licensed wholesalers and other authorized high-volume customers free of charge. This would allow them to easily record Bottle IDs, self-check their stock locally for Bottle ID duplicates, and automatically call-in so they can be alerted to other counterfeits. The software would also help prevent the customer from inadvertently calling in a given bottle twice, thus improving the accuracy of the results for the CNT method. If the reader and software record the Bottle IDs in an encrypted form, preferably with the use of a public/private key cipher, it would be more challenging for an adversary to steal the recorded valid Bottle IDs.

Anyone who calls in with an invalid Bottle ID (assuming that caller did not make a mistake and is not deliberately trying to spoof the CNT method) will be told correctly 100% of the time that he has counterfeit drugs. This is true regardless of the number of previous or subsequent callers.

Now consider the situation where there exists in the world 1 legitimate bottle, and N counterfeit bottles, all printed with the same valid Bottle ID. The probability that any one of these bottles chosen at random is counterfeit is N/(N+1). In this analysis, it is assumed that at least 2 of these (N+1) bottles are called in, which permits counterfeiting to be detected. TABLE 1 shows that the CNT error rate is very low in identifying counterfeits when the counterfeiters make even a relatively small number of counterfeit bottles with the same valid Bottle ID.

A threshold greater than 2 callers could be used before deciding that counterfeiting of a given Bottle ID has occurred. In general, when the number of callers that call in the same Bottle ID reaches some threshold value, T, counterfeiting will be reported to that caller and to all subsequent callers. If C is the total number of callers who call in the same valid Bottle ID, assuming that we do not try to re-contact previous callers who made an inquiry prior to the threshold T being achieved, the percentage of total callers who will be told they likely hold counterfeits is equal to 100%×(C−T+1)/C. This is plotted in FIG. 2 for four different threshold (T) values.

Even with a high threshold (e.g. T=10), a significant portion of callers may be correctly notified that they probably have a counterfeit. Once the threshold is achieved for a given Bottle ID, the T−1 previous callers (assuming they have offered their identity and contact information) may be re-notified to warn them that new information suggests they may have counterfeit pharmaceuticals. This would make all of the callers who report the same (valid) Bottle ID aware that they probably hold a counterfeit.

It should be noted that prior to reaching the threshold T for a given valid Bottle ID, the first T−1 callers may be invited to call back at a later time to see if the situation has changed. These callers may be encouraged to indicate they are checking back, so that their repeat call-in does not count towards the threshold T.

TABLE 2 shows the accuracy in telling the next caller that the caller has a counterfeit under the conditions that the same valid Bottle ID has already been called in multiple times, and that there exists 1 authentic bottle and N counterfeit bottles, all with the same valid Bottle ID. According to TABLE 2, by the time counterfeiters have made more than just a few replicates of the same Bottle ID, there is a high confidence that any of the bottles called in with that ID is a counterfeit.

TABLE 2

| Number | | |
|---|---|---|
| of counterfeits | Accuracy = | |
| made (N) | N/(N + 1) | Error rate |
| 2 | 67% | 33% |
| 10 | 91% | 9% |
| 100 | 99% | 1% |
| 1,000 | 99.9% | 0.1% |
| 10,000 | 99.99% | 0.01% |

Strategies for responding to customers who call in the token(s). The following messages may be given to a customer who calls in the numeric token:
1) For the first caller through caller T−1 for a given valid Bottle ID, where T is the counterfeiting threshold, the message might be “thank you for contributing to everybody's safety! We have no information at this time that there is a problem with your drugs but you can optionally (a) check back later, but be sure to tell us you are rechecking, or (b) give us your contact information and we will get back to you if new information becomes available.”
2) For the T^{th} caller and all subsequent callers for a given valid Bottle ID: “There is a very high probability you have a fake.”
3) Any caller with an invalid Bottle ID would receive a message that there is a 100% certainty that they have a fake, assuming they reported the Lot Number and Bottle ID accurately.

Self-checking strategy. A customer who does self-checking, and does not call in, may employ the following self-checking strategy. For the example of self-checking pill bottles, the self-checker knows with high probability that two or more pill bottles with duplicate Bottle IDs in the current stock of the self-checker are counterfeits. The self-checker knows with 100% certainty that at least one of pill bottles is a counterfeit. The self-checker knows with high probability that two or more pill bottles with duplicate Bottle IDs in current and past stock are counterfeits.

Some of the following scenarios illustrate possible attack strategies and countermeasures.

Scenario 1: Guessing Bottle IDs. Counterfeiters can randomly guess Bottle IDs. Their problem, however, is that the odds of guessing a valid Bottle ID for a given lot number are preferably less than 1 in 1000 because of Rule 3 (vide supra). As a result, fewer than about 0.1% of their counterfeit bottles will pass the call-in test. Even without calling in, high-volume customers may be able to use self-checking to identify counterfeits by detecting replicate Bottle IDs within their own stock.

Scenario 2: Phishing for Bottle IDs. Counterfeiters can always try to phish for valid Bottle IDs by calling in trial IDs, where “phishing” means trying to obtain private information by misrepresenting one's identity and agenda, and asking relevant questions. On average, however, it will take preferably at least 1000 tries to get a valid Bottle ID. This example of attack scenario may be minimized or eliminated if the callers are only given a Yes/No decision on their Bottle ID (and not allowed access to the whole database), and if unlimited inquiries from a single, unknown caller are disallowed if that caller inquires about a large number of invalid Bottle IDs. Also, deliberately putting a time delay into the call-in response can help to frustrate phishing. Requiring some form of identification, such as a password, drug business license, prescription number, or invoice number, is preferred for customers claiming to have a large stock.

Scenario 3: Other Ways to Obtain Valid Bottle IDs. Another approach that drug counterfeiters can use to obtain valid Bottle IDs is to buy some of the authentic product. They might also try to quickly examine large supplies of the product (without purchasing) in order to record valid Bottle IDs. As a practical matter, it is likely to be time consuming, expensive, risky, and/or difficult to obtain large numbers of valid Bottle IDs. This is especially the case if the Bottle IDs are placed inside the tamper-evident packaging. Counterfeiters may be more inclined to make duplicate Bottle IDs from a relatively small number of valid numbers, but these can be detected by CNT call-ins and self-checking. Valid bottle IDs could also be obtained as follows:
(1) Legitimate products are purchased, the Bottle IDs are extracted, and then the products are discarded. This method can be expensive for the counterfeiters.
(2) Legitimate products are purchased, the Bottle IDs extracted, and then the products are resold. Returning the authentic product to the marketplace may increase the chances that the counterfeiting may be detected and that the counterfeiter may be traced.
(3) Nefarious insiders may gain access to the (single) secret Bottle ID database kept by the pharmaceutical manufacturer at company headquarters. Good security, however, can minimize this possibility. Furthermore, the Bottle IDs stored in the database are of no value once the lots expire, or for future pharmaceuticals not yet manufactured or packaged.
(4) Nefarious insiders may gain access to significant numbers of valid Bottle IDs at high-volume handlers, or while pharmaceuticals are in transit. Good security can help minimize this risk.
(5) Counterfeiters can record valid Bottle IDs at retail stores or pharmacies. This may be difficult to do in large numbers, especially if the Bottle IDs are placed inside tamper-evident packaging.

Scenario 4: Denial of Service Attacks. Counterfeiters or hackers can try to sabotage the CNT system by Denial of Service (DoS) attacks. This involves tying up the call-in Internet website and telephone lines with nuisance contacts. Counterfeiters do not benefit directly from such actions, but they might discredit the CNT system and impede or upset customers.

DoS attacks can be at least partially mitigated by using standard DoS strategies and countermeasures that are often applied to the Internet, by requiring callers to identify themselves, and/or by setting up private Internet websites and telephone lines that are unavailable to the public for trusted, high-volume customers.

Scenario 5: Spoofing the “Call-in-the-numeric-token method. Counterfeiters or hackers may try to sabotage the CNT method by calling in valid Bottle IDs multiple times. Those Bottle IDs would then be incorrectly identified as having been counterfeited. Such spoofing is of no value unless the counterfeiters/hackers possess significant numbers of valid Bottle IDs that are difficult to obtain. This type of attack can be partially mitigated by raising the threshold, T, to a larger value than 2. As shown in FIG. 2, this only slightly reduces the overall efficiency of the CNT technique. Another countermeasure is to establish secret or private web pages and telephone lines for use only by trusted wholesalers, pharmacies, and hospitals. Also, requiring callers to identify themselves (such as via a password) can be useful, as can building in delays in the CNT method for individual consumers, which makes calling in large numbers of valid Button IDs very time consuming.

While they might discredit the CNT method and upset customers, counterfeiters or hackers do not benefit directly from spoofing the CNT method. Moreover, the attacks may backfire. Creating the appearance of extra drug counterfeiting could focus more worldwide attention on the drug-counterfeiting problem. This might encourage governments or pharmaceutical manufacturers to take additional anti-counterfeiting measures and increase prosecution, which is not in the best long-term interests of the counterfeiters.

Scenario 6: Fake Call-In Sites. Counterfeiters can establish fake Internet websites and telephone numbers that incorrectly tell callers that their pharmaceuticals are authentic, even when this is not the case. The counterfeiters might print their fake Internet address and telephone number on the counterfeit bottles, or placed them inside the counterfeit packaging. Pharmaceutical manufacturers can counter this attack by not including the address or telephone numbers for CNT call-ins on, or inside, the legitimate product or container. Instead, customers and consumers would be educated as to the correct Internet address or telephone number to use. This could be accomplished by an extensive national or worldwide advertising campaign, including listings in telephone books, memorable radio and television jingles, and the use of an Internet address and telephone number (e.g., 555-FAKE) that can be easily remembered.

Manufacturers might also want to periodically contact major customers directly to make sure they have the correct Internet address and telephone number. Providing free inventory and call-in software to high-volume customers might help prevent the use of bogus Internet addresses and telephone numbers. Sales representatives could be used to provide physicians and pharmacies with informational handouts for their patients. These would contain the correct Internet address and telephone number, as well as call-in instructions. It may also be prudent to continually scan the Internet to detect counterfeit call-in sites.

Scenario 7: Innocent Redundancy by Customers. Consumers or other customers might innocently call-in the same bottle more than once. This can skew the counterfeit detection. Countermeasures to this problem include, but are not limited to, (a) setting the threshold above 2, (b) using tear-off, scratch-off, or frangible printing for the Bottle ID to minimize reuse, (c) using read-once-then-erase magnetic or other recording media, (d) understanding the identity of the callers, and/or (e) providing high-volume customers with software that prevents this kind of error.

Scenario 8: Duplicate Calls Due to Drug Resale. Pharmaceuticals are often resold by the original purchaser. (The FDA has proposed that limiting the number of legal drug resales might be an effective anti-counterfeiting measure). Drug resales could lead to duplicate CNT call-ins for the same bottle if both the original and subsequent owners call in. There are several possible ways to deal with this issue. If the seller is a repackager, see scenario 9. Otherwise, the threshold could be increased beyond 2. Scratch-off labels that are read-once-then-erase magnetic or other recording media, or tear-off tabs for the Bottle ID to be missing for the second owner could be used. This would eliminate the duplication problem, but at the expense of offering no chance for the new owner to check on authenticity. The reseller could instead report to the pharmaceutical manufacturer the Bottle IDs were sold, though this requires extra work.

If both the original and new owners call-in and identify themselves, it is possible to check and see if the sale is going in the correct direction, e.g., not from consumer to wholesaler, or consumer to consumer. Another approach would be to limit the CNT method for use by only one class of customers: licensed wholesalers only, pharmacies only, or consumers only. Then reselling would be less of an issue, though the overall efficiency in detecting counterfeits would decrease. Separate and unconnected CNT systems could also be run for each class of customers.

Scenario 9: The Repackaging Problem. Single dose (“unit of use”) packaging would likely minimize problems associated with repackaging. The question of how to otherwise handle repackaging is an important one. According to the FDA, repackaging destroys anti-counterfeiting technologies employed by the manufacturer. With the CNT method, however, putting the Bottle ID inside tamper-evident packaging is not necessarily a problem for repackagers or pharmacies. They typically open the packaging anyway. It is important to recognize that the CNT Bottle ID is not necessarily a physical tag. Under the CNT method, a Bottle ID can be reused by repackaging the adhesive label imprinted with the Bottle ID, re-adhering it, or printing it again. If the repackager is consolidating small bottles into larger ones, he needs to only reuse a subset of the original Bottle IDs. He should then destroy the unused Bottle IDs because they might be stolen by, sold to, or otherwise acquired by counterfeiters, or if the repackager himself is a counterfeiter.

A more common situation where a repackager or pharmacy is “sub-dividing”, i.e., creating more new bottles than the number of old bottles may be handled in various ways. Repackagers may be required to obtain authorization from the pharmaceutical manufacturer, or be sent new printed labels, for imprinting new Bottle IDs. Alternatively, repackagers may inform the manufacturer that some of the Bottle IDs will be re-used. A manufacturer can factor this information into the CNT method and the choice of threshold.

A preferred approach is for the pharmaceutical manufacturer to pack a reasonable number of multiple Bottle IDs, each one different from the others, inside a single large bottle. The Bottle IDs could, for example, be in the form of adhesive labels, though there are other possibilities. Each new bottle created by an authorized repackager or pharmacy would then get one of these unique Bottle IDs that Rule 1 (vide supra), where a unique Bottle ID is created for each virtual or future bottle. The Bottle IDs represent an authorization to create a fixed number of new bottles. Unused Bottle IDs represent a vulnerability if made available to counterfeiters.

Fortunately, each unused Bottle ID that a repackager or pharmacy allows to fall into the hands of counterfeiters represents only one counterfeit bottle that the counterfeiters can safely make. If they replicate the diverted Bottle ID multiple times, the CNT call-in and self-checking system may be used to detect the counterfeits. Moreover, some traceability of the bootlegged Bottle IDs-pointing back to the guilty repackager or pharmacy—may be possible if CNT callers identify themselves.

Scenario 10: Identity & Privacy Issues. The security and effectiveness of the CNT method improves when callers identify themselves. For example, earlier callers can be re-contacted when it appears that a given Bottle ID has been counterfeited based reaching the call-in threshold. Also, instances of counterfeiting that are discovered may become traceable if the callers are known. A disadvantage of having callers identify themselves is that this may raise privacy concerns and possibly discourage consumers from participating. Moreover, having to type in one or more passwords and/or identity information during the call-in will slow down what would otherwise be a very rapid yes/no response on the Internet or telephone.

Scenario 11: The Best as the Enemy of the Good. The CNT method likely will not stop all counterfeiting, nor can the CNT method detect all counterfeits. Implementing partial measures to deal with hazards may put manufacturers in a risky situation with regard to liability. A possible countermeasure to this problem is to involve the government and/or make the CNT method, even if imperfect, an industry best practice. Due diligence could then be claimed even if the counterfeiting problem is not totally eliminated.

Another problem is how to deal with a caller who is told his drugs are likely to be counterfeit when they really aren't. This situation may occur when a valid Bottle ID is replicated by counterfeiters N times. One customer will possess the single authentic bottle with that Bottle ID. If that customer calls in, his sole authentic bottle cannot be distinguished from the N fakes. If his drugs are mailed in for analysis, however, he can be notified later of the error, and he can also be sent an apology and a statement that this was all in the interest of his safety and the greater good.

The CNT method is different from the FDA (United States Food and Drug Administration) proposed approach as outlined in a 2004 report entitled “Combating Counterfeit Drugs”. The FDA calls for “mass serialization” of pharmaceutical containers and extensive use of RFIDs for purposes of tracking “pedigree”. CNT differs from this approach in a number of ways. The CNT method is not a track and trace method while the FDA method is. The CNT method is much simpler and less expensive than retrofitting RFIDs in the pharmaceutical industry supply chain, or trying to maintain a continuous, complex history of the chain of custody for billions of drug products and containers. Unlike the FDA plan, the CNT method is voluntary and invites consumer involvement. Under the FDA plan, consumers won't be able to participate because few will own RFID readers. CNT does not require RFID, though RFID can be used to make the CNT technique more efficient and cost-effective. The Bottle ID is a token that does not necessarily need to be in or on the product or container. With CNT, there is no tag hardware for an adversary to counterfeit. Moreover, without any communication between the customer and the manufacturer or manufacturer's representative, the FDA track and trace completely fails. Without any communication between the customer and the manufacturer or manufacturer's representative for CNT, in contrast, self-checking will still be effective in detecting counterfeits. If desired, the CNT method can be implemented without the knowledge of customers by simply printing the Bottle IDs in/on the product, the container, the packaging, etc. The manufacturer can then activate the CNT method during a crisis, such as during a public drug-counterfeiting scare by publicizing that CNT method is now active.

Strategies for dealing with repackagers, consolidators, and resellers, include raising the threshold (T) above a value of 2 and generating or destroying Bottle IDs as needed. By contrast, the FDA track and trace does not have a strategy for dealing with repackagers, consolidators, and resellers, other than perhaps to require only single dose packaging.

The CNT method also differs significantly from the FDA's RFID “serialization code”. The FDA approach uses predictable serial numbers. For the CNT method, the Bottle ID is random or pseudo-random, unpredictable, and non-sequential, and it does not contain information about the product that can be used by counterfeiters to help guess valid numbers. Moreover, the CNT Bottle ID requires far fewer bytes (2-4) than the 12-byte minimum code envisioned by the FDA.

The CNT method also differs from other production or serial number authentication approaches. For example, it differs from conventional or hash-based calling-in of a product's serial number, which are based primarily on checking whether the caller has a valid serial number and perhaps hash or encrypted hash of that serial number. The CNT method does not require a hash or encryption, and thus no hash or encryption scheme that could be broken by a sophisticated adversary. The CNT Bottle ID is not predictable or sequential as with conventional product serial numbers. Self-checking is not ordinarily a part of conventional product authentication schemes, nor is combining the results from multiple customers to assist other customers in determining product authenticity.

The CNT method has a strategy for dealing with multiple call-ins of the same Bottle IDs. Conventional authentication schemes do not.

The CNT method does not require maintaining and interpreting data on the origin and transport/ownership history of each lot and serial number, unlike many conventional track and trace authentication methods. CNT is thus much simpler than these other methods.

Unlike other authentication methods, the CNT method recognizes that the manufacturer cannot simply print the web page address or telephone number for call-ins in or on the product. This is because the counterfeiters could print Internet web addresses and telephone numbers to their own fake locations that would tell callers the wrong information about authenticity. The CNT method recognizes that the web address and telephone numbers must be conveyed to customers and consumers via widespread publicity, or other means.

The Bottle ID will typically only be 2-4 bytes, unlike traditional long serial numbers that take a long time to type in.

The Bottle ID may be placed inside tamper-evident packaging, thus making it more difficult for adversaries to easily and surreptitiously obtain large numbers of valid Bottle IDs. This is rare for other more conventional product authentication methods.

Scratch-off, tear-off, or read-once-and-erase Bottle IDs that are optionally used with the CNT method may decrease the odds that a customer will mistakenly call-in the same Bottle ID more than once. These types of IDs are not used with more conventional product authentication methods.

Asking customers—especially individual consumers—to take personal responsibility for checking the authenticity of their own medicines may have significant educational, behavioral, legal, and public health benefits. Fortunately, customers who aren't concerned about counterfeiting will not be bothered. They can just ignore the CNT method. CNT publicity campaigns probably need to emphasize to consumers what they have to gain by calling-in, but should also point out that their participation can help others.

For pharmaceutical companies, information provided by CNT callers can lead to a better understanding of customers and the market. Pharmaceutical companies may also benefit from enhanced public and government good will by taking proactive measures to deal with counterfeiting. Moreover, if CNT callers can be encouraged to mail in their counterfeit pharmaceuticals, we stand to learn more about the nature and extent of counterfeiting, and perhaps can more rapidly identify public health risks.

Importantly, with the CNT method, a customer who calls in helps determine the authenticity of the product (e.g. pill bottles) for subsequent callers. This aspect of the CNT method can be used to increase customer participation. It is believed that this altruistic aspect of the CNT method is absent from other methods.

Consumers might find it particularly easy to hold the bottle up to the telephone, press a button on a microchip, and let the bottle “beep” its Lot Number and Bottle ID into the telephone using standard telephone touch tone frequencies (Dual Tone Multiple Frequency or DTMF). (DTMF would work even for telephone systems in countries that don't use DMTF for making telephone connections.) Currently, microcircuits on greeting cards can talk or sing. These cost under $2 each in quantity, including the battery, and prices are expected to decrease over time.

Nowadays, the printing of individual numbers onto containers or adhesive labels in a moving assembly line is inexpensive. Costs are also modest for maintaining a single automated CNT databases, which could be implemented on a single personal computer. The costs of establishing and running a CNT Internet website should also be modest because the Internet website is little more than a big look-up table. Having a bank of automated, voice-recognition telephone lines for CNT callers, on the other hand, would be more expensive. The greatest cost associated with implementing the CNT method would likely be incurred in educating customers and the public, including consumers, pharmacists, and physicians about the CNT method and which Internet address or telephone number to use.

Initially, the use of a CNT system might be limited to high-volume customers only. Pharmaceutical companies might also keep costs down by establishing a joint CNT system with other manufacturers, or by seeking government sponsorship.

If Bottle IDs are printed in advance as adhesive labels or inserts, the entire CNT method could be run by a third party as a relatively small service business. Bottle IDs would be securely provided to pharmaceutical manufacturers as needed. Responsibility for maintaining the CNT database and operating the Internet website and telephone lines would rest with the service provider.

It is believed that implementing a CNT system will demonstrate good faith on the part of manufacturers in attempting to deal with the problem of counterfeiting. Customers are encouraged to check on the validity of any token found on or in the objects that they possess, or to self-check their own large past and present inventory. Invalid tokens can be recognized quickly by calling in, while duplicates may be detected by a self-check. Furthermore, the pooling of information from callers helps to spot (and perhaps trace) tokens that have been illegally replicated by counterfeiters. Counterfeiters are hampered by the fact that guessing valid IDs (i.e. valid tokens) isn't practical. Counterfeiters are also hampered by the fact that replicate valid IDs may be detected by the call-in process. In addition, obtaining large numbers of valid ones will be challenging for a counterfeiter. While the CNT method cannot stop all counterfeiting, it may impede counterfeiters at relatively modest cost. It does not require expensive, high-tech devices that are vulnerable to simple attacks, and it makes use of common technologies that are readily available such as the Internet and the telephone.

The foregoing description of the invention has been presented for purposes of illustration and description and is not intended to be exhaustive or to limit the invention to the precise form disclosed, and obviously many modifications and variations are possible in light of the above teaching. For example, while many of the embodiments described are concerned with pill bottles and Bottle IDs, it should be understood that the invention may be used to providing a token for any object and a method for checking whether or not the object is a counterfeit. The method may be used for objects produced in any quantity, and is particularly effective with objects that are mass-produced.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for generating tokens, comprising generating a plurality of IDs for a set of objects, each ID comprising a randomly or pseudo-randomly generated, unpredictable string of letters, digits, symbols or colors, wherein the number of object IDs is at least 100 times greater than the number of objects in the set, wherein no two object IDs are the same for the set of objects.

2. The method of claim 1, wherein the IDs comprise container IDs or product IDs, and wherein the objects comprise containers or products.

3. A method for providing each of a plurality of objects with an object ID, comprising:
(a) generating a plurality of object IDs for a set of objects, each object ID comprising a randomly or pseudo-randomly generated, unpredictable string of letters, digits, symbols or colors, wherein the number of object IDs is at least 100 times greater than the number of objects in the set, wherein no two object IDs are the same for the set of objects;
(b) assigning one of the object IDs to each object in the set of objects, the set of objects comprising a lot having a lot number;
(c) repeating step (b) for the remaining objects of the lot, wherein no two objects are assigned the same object ID in the lot.

4. The method of claim 3, wherein an object is selected from the group consisting of products, containers, and products inside containers, and wherein an object ID is selected from the group consisting of product IDs and container IDs.

5. The method of claim 4, further comprising labeling each container by putting a container ID on the container.

6. The method of claim 4, further comprising labeling each container by putting each container ID in the container.

7. The method of claim 3, further comprising locating the object IDs away from the objects.

8. The method of claim 3, further comprising storing each object ID on a storage medium.

9. The method of claim 8, wherein the storage medium comprises a database.

10. The method of claim 3, further comprising repeating steps (a), (b), and (c) for another lot.

11. The method of claim 3, wherein the plurality of object IDs is at least 1000 times greater than the number of objects in the lot.

12. Labeled objects prepared by a method comprising:
(a) generating a plurality of object IDs for a set of objects, each object ID comprising a randomly or pseudo-randomly generated, unpredictable string of letters, digits, symbols or colors, wherein the number of object IDs is at least 100 times greater than the number of objects in the set, wherein no two object IDs in the set are the same;
(b) assigning one of the object IDs to each object in the set of objects, the set of objects comprising a lot having a lot number;
(c) labeling each object; and
(d) repeating step (b) and step (c) for the remaining objects of the lot, wherein no two objects are assigned the same object ID in the lot.

13. The labeled objects of claim 12, wherein said labeled objects are selected from the group consisting of labeled products, labeled containers, labeled products inside unlabeled containers, and labeled products inside labeled containers, and wherein the object IDs are selected from the group consisting of product IDs and container IDs.

14. The labeled objects of claim 13, wherein labeling each container comprises putting a container ID on each container.

15. The labeled objects of claim 13, wherein labeling each container comprises putting a container ID in each container.

16. The labeled objects of claim 13, wherein the plurality of container IDs is at least 1000 times greater than the number of containers in the lot.

17. A method for reporting to a customer the likelihood that a product from a lot is counterfeit, wherein each product in the lot having a lot number and a product ID, the product ID comprising a randomly or pseudo-randomly, unpredictable generated string of letters, digits, symbols or colors, the method comprising:
(a) calling in a lot number and a product ID from a customer to a manufacturer of a product or representative of a manufacturer of a product;
(b) storing the called in lot number and product ID in a first database;
(c) comparing the lot number and product ID to a second database of valid product IDs for the lot number;
(d) determining whether or not the product ID has been called in previously for the lot number;
(e) determining the likelihood that the product is a counterfeit based on results of step (c) and step (d); and
(f) communicating the likelihood that the product is a counterfeit to the customer.

18. The method of claim 17, wherein step (e) comprises determining that the product is counterfeit because the product ID called in from the customer to the manufacturer or representative is not in the second database for the communicated lot number.

19. The method of claim 17, wherein step (e) comprises determining that the product is likely counterfeit because the product ID for the called in lot number has already been called in.

20. The method of claim 17, wherein step (e) comprises determining that the product is likely counterfeit because the product ID for the called in lot number has already been called in P times where P+1≧T, where T is an integer greater than 2.

21. The method of claim 17, wherein step (f) comprises communicating to the first caller through caller number T−1 who have called in the same valid product ID that their product does not appear to be a counterfeit and optionally that the caller can check back later if they identify themselves as recheckers or provide contact information and the manufacturer or manufacturer's representative will contact the caller if new information becomes available, where T is an integer that has been chosen as a threshold for declaring that a chosen product ID is a counterfeit, and communicating to caller numbers T and greater than T that they likely have a counterfeit product.

22. The method of claim 17, further comprising:
(g) updating the first database with each newly called-in lot numbers and product IDs.

23. A method for reporting to a customer the likelihood that a product is counterfeit, the product being inside a container, the container having a lot number and a container ID, the container ID comprising a randomly or pseudo-randomly, unpredictable generated string of letters, digits, symbols or colors, the method comprising:
(a) calling in the lot number and the container ID from a customer to a manufacturer of a product or a representative of a manufacturer of a product;
(b) storing the called in lot number and container ID in a first database;
(c) comparing the lot number and container ID to a second database, the second database comprised of valid container IDs for the lot number;
(d) determining whether or not the container ID has been called in previously for the lot number;
(e) determining the likelihood that the product is a counterfeit based on the results of step (c) and step (d); and
(f) reporting to the customer the likelihood that the product is a counterfeit.

24. The method of claim 23, wherein step (e) comprises determining that the product is counterfeit because the container ID called in from the customer to the manufacturer or representative is not in the second database for the communicated lot number.

25. The method of claim 23, wherein step (e) comprises determining that the product is likely counterfeit because the container ID for the called in lot number has already been called in.

26. The method of claim 23, wherein step (e) comprises determining that the product is likely counterfeit because the container ID for the called in lot number has already been called in P times where P+1≧T, where T is an integer greater than 2.

27. The method of claim 23, wherein step (f) comprises communicating to the first caller through caller number T−1 who have called in the same valid container ID that their product in the container does not appear to be a counterfeit and optionally that the caller can check back later if they identify themselves as recheckers or provide contact information and the manufacturer or manufacturer's representative will contact the caller if new information becomes available, where T is an integer that has been chosen as a threshold for declaring that the product in the container having the container ID is a counterfeit, and communicating to caller numbers T and greater than T that they likely have a counterfeit product.

28. The method of claim 23, further comprising:
(g) updating the first database with each newly called-in lot numbers and container IDs.

29. A self-checking method for detecting a counterfeit product among a plurality of products currently or previously owned by a customer, each product of the plurality of products having a lot number and a product ID comprising a randomly or pseudo-randomly generated, unpredictable string of letters, digits, symbols or colors, the method comprising:
(a) maintaining a database of lot numbers and product IDs for each lot number and each product of the plurality of products;
(b) determining whether or not there are any duplicate product IDs for each lot number; and thereafter
(c) determining the likelihood of whether any of the products are counterfeit.

30. A self-checking method for detecting a counterfeit product among a plurality of products currently or previously owned by a customer, each product of the plurality of products being inside a container, the container having a lot number and a container ID comprising a randomly or pseudo-randomly generated, unpredictable string of letters, digits, symbols or colors, the method comprising:
(a) maintaining a database of lot numbers and container IDs for each lot number and each container;
(b) determining whether or not there are any duplicate container IDs for each lot number; and thereafter
(c) determining the likelihood of whether any of the products are counterfeit.

31. A system for a container, comprising:
(a) a microprocessor for storing and transmitting information that is stored in the microprocessor, the stored information comprising a lot number and a container ID for said container;
(b) an acoustic encoder and driver for controlling a speaker, said acoustic encoder and driver being in electrical communication with said microprocessor;
(c) a speaker in communication with said microprocessor and said acoustic encoder and driver for sending an acoustic signal that comprises the lot number and the container ID;
(d) an actuator for initiating the acoustic signal from said speaker; and
(d) a source of electrical power in electrical communication with said microprocessor, said acoustic encoder and driver and said speaker.

32. The system of claim 31, wherein said stored information further comprises a product ID for any product inside said container.

33. The system of claim 31, wherein the stored information and the acoustic signal include the number of times that the actuator has been initiated.

34. The system of claim 31, wherein no more than 4 acoustic signals can be initiated using the actuator.

35. The system of claim 31, wherein said system is attached to the container.
